(19) United States
(12) Patent Application Publication
(10) Pub. No.: US 2025/0315597 A1
(43) Pub. Date: Oct. 9, 2025

(54) METHOD FOR CONTROLLING A DATA BLOCK, ELECTRONIC DEVICE, AND STORAGE MEDIUM

(71) Applicant: Beijing Zitiao Network Technology Co., Ltd., Beijing (CN)

(72) Inventors: Hengyu ZHANG, Beijing (CN); Zongyan WEI, Beijing (CN)

(21) Appl. No.: 18/864,817

(22) PCT Filed: May 8, 2023
(86) PCT No.: PCT/CN2023/092714

§ 371 Date: Nov. 11, 2024

(30) Foreign Application Priority Data
May 11, 2022 (CN) 202210515870.7

(51) Int. Cl. G06F 40/166

(52) U.S. Cl. CPC G06F 40/166

(57) ABSTRACT

A method, an apparatus and a system for controlling a data block, an electronic device, and a storage medium is provided. The method includes, receiving a target operation being performed on a first data block in a first document, the first data block having a reference relationship with a second document and the target operation including inserting, deleting, moving or replacing a sub-data block under the first data block; and updating the reference relationship between at least one data block in the first document and the second document on the basis of the target operation.

### CROSS-REFERENCE TO RELATED APPLICATION

This application claims the priority of the Chinese patent application with the application number 202210515870.7 and the title of “METHOD, APPARATUS AND SYSTEM FOR CONTROLLING A DATA BLOCK, ELECTRONIC DEVICE AND STORAGE MEDIUM” filed by Patent Office of China on May 11, 2022, the entire contents of which are incorporated herein by reference.

### TECHNICAL FIELD

The present disclosure relates to the field of computer technologies, and specifically relates to a method, apparatus and system for controlling a data block, an electronic device and a storage medium.

### BACKGROUND

Relevant online document technology can provide real-time referencing function, that is, users can reference a continuous section of content from another online document in one online document, and when the referenced content is modified in the original document/reference document, it can also be updated in the corresponding reference document/original document. In this way, a section of content can appear in multiple documents and be synchronized in real-time, which can to some extent improve the utilization rate of the documents. However, the real-time referencing function provided by relevant online document technologies is not perfect, and it is easy to encounter the problem of losing the referenced parts, which brings inconvenience to users.

### SUMMARY

The section of summary of the invention to briefly introduce the concepts is provided, which will be described in detail in the detailed description later. The section of summary of the invention is not intended to identify the key or necessary features of the claimed technical solution for protection, nor is it intended to limit the scope of the claimed technical solution for protection.

In a first aspect, according to one or more embodiments of the present disclosure, a method of controlling a data block is provided. The method includes:
in response to a target operation being performed on a first data block in a first document, determining whether the first data block has a reference relationship with a second document, wherein the target operation is used for inserting, deleting, moving or replacing a sub-data block under a data block; and
in response to the first data block being determined to have the reference relationship with the second document, updating the reference relationship between at least one data block in the first document and the second document on the basis of the target operation.

In a second aspect, according to one or more embodiments of the present disclosure, a method of controlling a data block is provided. The method includes:
determining a referenced data block in a first document, the referenced data block having a reference relationship with a second document;
in response to a target operation being performed on the referenced data block, changing a position of the referenced data block in the first document; and
in response to the position of the referenced data block being changed in the first document, keeping the reference relationship between the second document and the referenced data block.

In a third aspect, according to one or more embodiments of the present disclosure, a method for controlling a data block is provided. The method is applied to a client and includes:
receiving selected region updating information transmitted by a server, the selected region updating information being determined by a server on the basis of the following steps: in response to a target operation being performed on a first data block, determining whether the first data block is an associated data block of a selected region; in response to the first data block being determined to be the associated data block of the selected region, re-determining the associated data block and/or range of the selected region on the basis of the target operation; determining the selected region updating information on the basis of the re-determined associated data block and/or range of the selected region, wherein the selected region is organized to describe a position and range of a referenced data block through the associated data block of the selected region and the range of the selected region, and the referenced data block is a data block referenced by at least one online document; and
updating the selected region on the basis of the selected region updating information.

In a fourth aspect, according to one or more embodiments of the present disclosure, an apparatus for controlling a data block is provided. The apparatus includes:
a determination unit, configured to, in response to a target operation being performed on a first data block in a first document, determine whether the first data block has a reference relationship with a second document, wherein the target operation is used for inserting, deleting, moving or replacing a sub-data block under a data block; and
an updating unit, configured to, in response to the first data block having the reference relationship with the second document, update the reference relationship between at least one data block in the first document and the second document on the basis of the target operation.

In a fifth aspect, according to one or more embodiments of the present disclosure, an apparatus for controlling a data block is provided. The apparatus includes:
a referenced data block determination unit, configured to determine a referenced data block in a first document, the referenced data block having a reference relationship with a second document;
a position changing unit, configured to, in response to a target operation being performed on the referenced data block, change a position of the referenced data block in the first document; and
a referencing unit, configured to, in response to the position of the referenced data block being changed in the first document, keep the reference relationship between the second document and the referenced data block.

In a sixth aspect, according to one or more embodiments of the present disclosure, an apparatus for controlling a data block is provided. The apparatus includes:
an information receiving unit, configured to receive selected region updating information transmitted by a server, the selected region updating information being determined by the server on the basis of the following steps: in response to a target operation being performed on a first data block, determining whether the first data block is an associated data block of the selected region; in response to the first data block being determined to be the associated data block of the selected region, re-determining the associated data block and/or range of the selected region on the basis of the target operation; determining the selected region updating information on the basis of the re-determined associated data block and/or range of the selected region, wherein the selected region is organized to describe the position and range of a referenced data block through the associated data block of the selected region and the range of the selected region, and the referenced data block is a data block referenced by at least one online document; and
a selected region updating unit, configured to update the selected region on the basis of the selected region updating information.

In a seventh aspect, according to one or more embodiments of the present disclosure, a system for controlling a data block is provided. The system includes:
a server including the apparatus for controlling a data block provided in the fourth aspect; and
at least one terminal including the apparatus for controlling a data block provided in the above sixth aspect.

In an eighth aspect, according to one or more embodiments of the present disclosure, an electronic device is provided. The electronic device includes: at least one memory and at least one processor. The memory is configured to store program codes, and the processor is configured to call the program codes stored in the memory to enable the electronic device to execute the method for controlling a data block provided by one or more embodiments of the present disclosure.

In a ninth aspect, according to one or more embodiments of the present disclosure, a non-transient computer storage medium is provided. Program codes are stored in the non-transient computer storage medium; and when the program codes are executed by a computer device, the computer device is enabled to execute the method for controlling a data block provided by one or more embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, the same or similar drawing reference signs represent same or similar elements. It should be understood that the drawings are schematic, and originals and elements may not necessarily be drawn to scale.

FIG. 1 is a flowchart of a method for controlling a data block according to an embodiment of the present disclosure;

FIG. 2 is a schematic diagram of an online document according to an embodiment of the present disclosure;

FIG. 3 is a schematic diagram of an online document according to another embodiment of the present disclosure;

FIG. 4 is a schematic diagram of a node relationship of data blocks according to an embodiment of the present disclosure;

FIG. 5 is a flowchart of a method for controlling a data block according to an embodiment of the present disclosure;

FIG. 6 is a flowchart of a method for determining a range of a selected region on the basis of a target operation according to an embodiment of the present disclosure;

FIG. 7 is a flowchart of a method for determining a range of a selected region on the basis of a target operation according to an embodiment of the present disclosure;

FIG. 8 is a schematic diagram of column division according to an embodiment of the present disclosure;

FIG. 9 is a flowchart of a method for controlling a data block according to yet another method of the present disclosure;

FIG. 10 is a flowchart of a method for controlling a data block according to yet another method of the present disclosure;

FIG. 11 is a structural schematic diagram of an apparatus for controlling a data block according to an embodiment of the present disclosure;

FIG. 12 is a structural schematic diagram of an apparatus for controlling a data block according to another embodiment of the present disclosure; and

FIG. 13 is a structural schematic diagram of an electronic device according to an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments.” The term “responsive to” and related terms refer to a signal or event being affected to a certain extent by another signal or event, but not necessarily completely or directly. If event x occurs in response to event y, then x can directly or indirectly respond to y. For example, the occurrence of y may ultimately lead to the occurrence of x, but there may be other intermediate events and/or conditions. In other cases, y may not necessarily lead to the occurrence of x, and even if y has not yet occurred, x may still occur. In addition, the term “responsive to” can also mean “at least partially responsive to.”

The term “determining” encompasses a wide range of actions, including acquiring, calculating, processing, deducting, researching, searching (e.g. searching in tables, databases, or other data structures), exploring, and similar actions. It may also include receiving (e.g. receiving information), accessing (e.g. accessing data in storage), and similar actions, as well as parsing, selecting, choosing, establishing, and similar actions. The relevant definitions of other terms will be provided in the following description. The relevant definitions of other terms will be provided in the following description.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

For the purpose of this disclosure, the phrase “A and/or B” means (A), (B), or (A and B).

The names of the messages or information exchanged between multiple devices in embodiments of the present disclosure are for illustrative purposes only and are not intended to limit the scope of these messages or information.

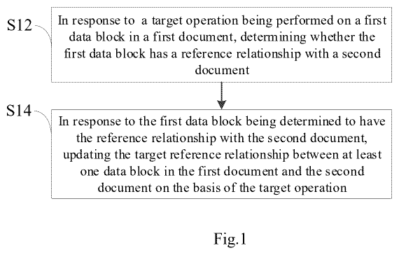

As shown in FIG. 1, FIG. 1 shows a method for controlling a data block according to an embodiment of the present disclosure, the method including step S12 and step S14.

Step S12: In response to a target operation being performed on a first data block in a first document, determining whether the first data block has a reference relationship with a second document, the target operation being used for inserting, deleting, moving or replacing a sub-data block under a data block.

In some embodiments, the data block (Block) is used as a basic unit for editing an online document and can be configured to display information such as character information, image information or multimedia information. One data block can be configured to display one or more paragraphs of text, and a plurality of data blocks can be the sub-data blocks of another data block.

In some embodiment, the second document is a document other than the first document. In one implementation, the second document can be any one or more online documents other than the first document. In another implementation, the second document can be one or more specific online documents other than the first document.

It is to be noted that unless otherwise specified, the reference relationship between the data block and the document in this embodiment includes that one or more sub-data blocks of this data block are referenced by this document, or one or more sub-data blocks of this data block are referenced from the document.

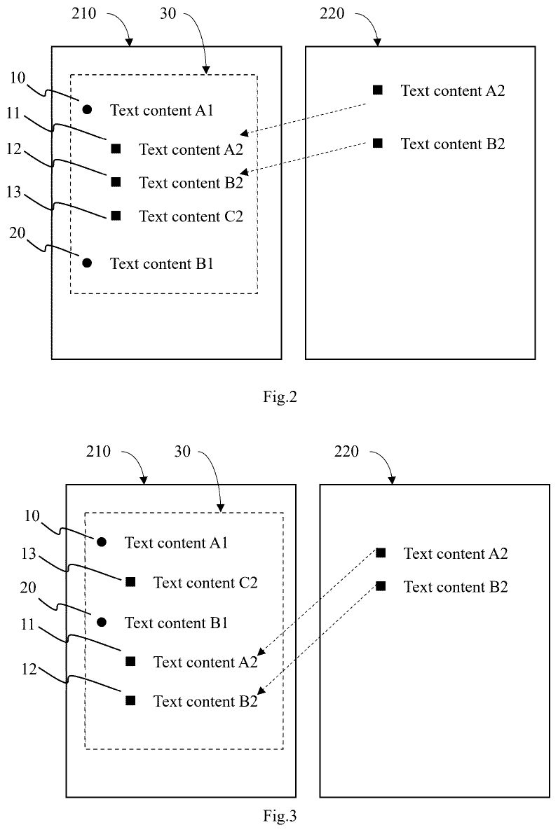

As shown in FIG. 2, FIG. 2 shows a schematic diagram of an online document according to the embodiment of the present disclosure. In a first online document 210, data blocks 10, 11, 12, 13 and 20 sequentially display text information such as “text content A1”, “text content A2”, “text content B2”, “text content C2” and “text content B1” respectively. The data blocks 11, 12 and 13 are sub-data blocks of the first data block 10, and the first data block 10 and the second data block 20 is a sub-data block of a data block 30. In addition, the data block 30 can also be a sub-data block of other data blocks, which is not limited in this embodiment. A second online document 220 references the data blocks 11 and 12 of the first online document 210, that is, there is a reference relationship between the second online document 220 and the first data block 10.

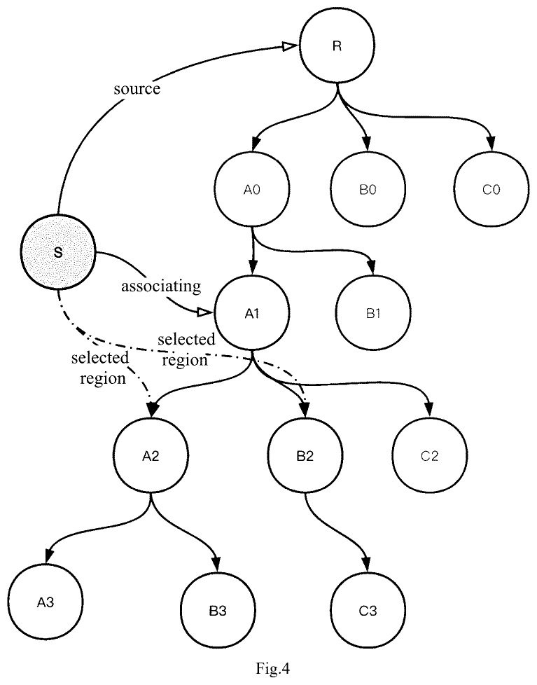

FIG. 4 shows a schematic diagram of a node relationship of data blocks according to an embodiment of the present disclosure. In FIG. 4, each node can correspond to one data block, and a root node R has nodes A0, B0 and C0, that is, the root node is a parent node of the nodes A0, B0 and C0; the node A0 has nodes A1 and B1, that is, the node A0 is a parent node of the nodes A1 and B1; the node A1 has nodes A2, B2 and C2, that is, the node A1 is a parent node of the nodes A2, B2 and C2; the node A2 has nodes A3 and B3, that is, the node A2 is a parent node of the nodes A3 and B3; and the node B3 has a node C3, that is, the node B2 is a parent node of the node C3.

In one specific implementation, the target operation can support inserting, deleting, moving or replacing items in a list, and shuffle (Shuffling) adjacent list items as required. For example, an instruction “{p:[path,idx], li:obj}” can be used for inserting an object “obj” before an item with an index of “idx” in the list; an instruction “{p:[path,idx], ld:obj}” can be used for deleting the object “obj” with the index of “idx” in the list; an instruction “{p:[path,key], oi:obj}” can be used for inserting the object “obj” into an object at [path]; and an instruction “{p:[path,key], od:before, oi:after}” can be used for replacing the object “before” with the object “after”.

FIG. 4 is taken as an example for description. In response to deletion of the data block B2 from the data block A1 as required, an instruction {p:[“children”,1], ld:“B2” }can be adopted; in response to insertion of the data block D2 between the data block A2 and the data block B2, an instruction {p:[“children”,1], li:“D2” }can be adopted; and in response to replacement of the data block A2 and the data block B2 by a data block D2 and a data block E2, an instruction {p:[path,key], od:before, oi:after}can be used.

Step S14: In response to the first data block being determined to have the reference relationship with the second document, determining the reference relationship between at least one data block in the first document and the second document on the basis of the target operation.

In some embodiments, step S14 includes: updating the reference relationship between the first data block and the second document on the basis of the target operation. If the target operation is to move all or the largest number of referenced data blocks referenced by the second document under the first data block to the second data block in the first document, step S14 further includes: determining the reference relationship between the second data block and the second document on the basis of the target operation.

In some embodiments, the reference relationship between the first data block and the second document can be updated on the basis of a relative position relationship between the data block targeted by the target operation and other sub-data blocks of the first data block under the first data block.

In some embodiments, the reference relationship between the second data block and the second document can be determined on the basis of the relative position relationship between the referenced data blocks moved to the second data block by the target operation and other sub-data blocks of the second data block.

Examples are provided below for description.

It is assumed that the data block A1 in the first document has three sub-data blocks A2, B2 and C2 in sequence, the second document references the 2-3 sub-data blocks (B2 and C2) under the data block A1; if a user inserts or deletes one sub-data block after the C2, the data block referenced by the second document is still the 2-3 sub-data blocks (B2 and C2) under the data block A1; if the user inserts 1 sub-data block before the B2, the data block referenced by the second document is changed into the 3-4 fourth sub-data blocks (B2 and C2) under the data block A1; if the user deletes the sub-data block A2, the data block referenced by the second document is changed into the 1-2 sub-data blocks (B2 and C2) under the data block A1; and if the user inserts 1 sub-data block X2 between the B2 and the C2, the data block referenced by the second document is changed into the 2-4 sub-data blocks (B2, X2 and C2) under the data block A1.

It is assumed that the sub-data blocks A2, B2 and C2 of the first data block A1 of the first document are all referenced by the second document, and if the user drags the sub-data blocks A2 and B2 to be under the second data block B1 of the first document, and drags the sub-data block C2 to be under a third data block C1 of the first document, a reference relationship between the second document and the second data block B1 can be created. Further, if the second data block B1 does not have the sub-data blocks originally, the reference relationship can be further determined as the 1-2 data blocks under the referenced data block B1 of the second document; if the second data block B1 has sub-data blocks D4 and E4 originally in sequence, and the referenced sub-data blocks A2 and B2 are dragged to be before the sub-data blocks D4 and E4, the reference relationship is further determined as the 1-2 data blocks under the referenced data block B1 of the second document; if the sub-data blocks A2 and B2 are dragged to be after the original sub-data blocks D4 and E4 of the second data block B1, the reference relationship is further determined as the 3-4 data blocks under the referenced data block B1 of the second document; and if the sub-data blocks A2 and B2 are dragged to be between the sub-data blocks D4 and E4, the reference relationship is further determined as the 2-3 data blocks under the referenced data block B1 of the second document.

As such, according to one or more embodiments of the present disclosure, in response to the target operation being performed on the first data block in the first document, whether the first data block has the reference relationship with the second document is determined; and in response to the first data block being determined to have the reference relationship with the second document, the reference relationship between the at least one data block in the first document and the second document is updated on the basis of the target operation, thus realizing the synchronous updating of the referenced data blocks.

According to one or more embodiments of the present disclosure, a method for controlling a data block is provided and includes:

Step S120: In response to a target operation being performed on a first data block, determining whether the first data block is an associated data block of a selected region. The selected region is organized to describe a position and range of referenced data blocks through the associated data block of the selected region and the range of the selected region; and the referenced data block is a data block referenced by at least one online document.

Step S140: In response to the first data block being the associated data block of the selected region, re-determining the associated data block and/or range of the selected region on the basis of the target operation.

According to one or more embodiments of the present disclosure, the selected region can be set to describe the position and range of the referenced data block. FIG. 4 is taken as an example for schematic explanation, it is assumed that the indexes of the data blocks A2, B2 and C2 are 0, 1 and 2 in sequence, and the data blocks A2 and B2 are the referenced data blocks, an associated data block (or an associated node) of a selected region S can be set as A1 and the range of the selected region S can be set as [0, 1], which represents that data blocks corresponding to a node (the node A2) with index of 0 under the node A1, a sub-node (the node B2) with index of “1” and sub-nodes (if any) between the node A1 and the node B2 are the referenced data blocks. “0” represents the start index, “1” represents the end index, and the range of the selected region is a closed interval.

It is to be noted that the range of the selected region can also be other numerical values, numerical value ranges and numerical value intervals, which is not limited here in this embodiment. The first data block in this embodiment can be located in the original document and can also be located in a reference document, and the reference document is an online document referencing one or more data blocks of the original document, which is not limited here in this embodiment.

In some embodiments, one selected region is configured to describe one data block or a set of consecutive data blocks. In some embodiments, if the target operation is to move all or the largest number of the referenced data blocks under the first data block to be under the second data block, the associated data block of the selected region is changed from the first data block to the second data block.

It is to be noted that unless otherwise specified, the “data block under/within the data block A” according to the present disclosure is the sub-data block of the data block A, and the “move the data block A to be under/within the data block B” according to the present disclosure is to move the data block A to be under/within the data block B to make the data block A as the sub-data block of the data block B.

In one specific implementation, for example, referring to FIGS. 2-3, if the user drags referenced data blocks 11 and 12 under the data block 10 to be under the data block 20 in the first online document 210, the associated data block of the selected region can be correspondingly modified from the original data block 10 to the data block 20. Referring FIG. 4, if the user drags the referenced data blocks corresponding to the nodes A2 and B2 to be under a data block corresponding to the node B1, the associated data block (or associated node) of the selected region are modified from the original “A1” to “B1”.

Further, in some embodiments, on the basis of the relative position relationship between the referenced data block moved to be under the second data block by the target operation and other sub-data blocks of the second data block, the range of the selected region is re-determined.

In one specific implementation, referring FIG. 4, the associated data block of the selected region S is A1, and the range is a closed interval [0, 1]. When the user drags the referenced data blocks A2 and B2 to be under the data block B1, the associated data block (or an associated node) of the selected region is determined to be “B1” from original “A1”, and then the range of the selected region can be re-determined on the basis of the relative position relationship between the referenced data block under the data block B1 and other sub-data blocks of the data block B1. In this embodiment, because the B1 does not have other sub-data blocks originally, the range of the selected region can still be [0, 1].

In another specific implementation, if the data block B1 has other sub-data blocks such as the data block D2 originally, when the referenced data block corresponding to the data blocks A2 and B2 is dragged to be after the data block D2, the left and right interval values of the range of the selected region can be correspondingly added by 1 and updated to be [1, 2], and the data blocks corresponding to a node (the dragged A2) with the index of 1, a sub-node (the dragged A2) with the index of 2 and a sub-node (if any) between the node A2 and the sub-node B2 under the node B1 are the referenced data blocks; when the referenced data block corresponding to the data blocks A2 and B2 is dragged to be before the data block corresponding to the data block D2, namely the data blocks A2 and B2 are still located at the first two positions under the data block B1, the range of the selected region can still be [0, 1].

In one specific implementation, if the user drags the referenced data blocks of the first data block into other different data blocks respectively, the dragged referenced data blocks with the largest number can be used as new associated data blocks of the selected region, and the range of the selected region is re-determined on the basis of the relative position relationship between the referenced data blocks under the new associated data blocks and other sub-data blocks. For example, if all sub-data blocks A2, B2 and C2 (corresponding to indexes 0, 1 and 2 respectively) of the first data block A1 are the referenced data blocks, the associated data block of the selected region S can be A1, and the range can be [0, 2]; when the user drags the sub-data blocks A2 and B2 to be under the second data block B1, and drags the sub-data block C2 to the third data block C1, the associated data block of the selected region can be modified from the original first data block A1 to the second data block B1; if the second data block B1 does not have sub-data blocks originally, the range of the selected region is [0, 1], that is, the first data block (the dragged sub-data block A2) and the second data block (the dragged sub-data block B2) under the second data block B1 are the referenced data blocks; if the second data block B1 has sub-data blocks D4 and E4 originally, and the referenced sub-data blocks A2 and B2 are dragged to be before the sub-data blocks D4 and E4, the range of the selected region is still [0, 1], that is, the first two sub-data blocks under the second data block B1 are the referenced data blocks; if the sub-data blocks A2 and B2 are dragged to be after the original sub-data blocks D4 and E4 of the second data block B1, the corresponding values of the left and right selected regions in the range are added by 2 and updated to be [2, 3], that is, the third sub-data block and the fourth sub-data block under the second data block B1 are the referenced data blocks; and if the sub-data blocks A2 and B2 are dragged to be between the sub-data blocks D4 and E4, the corresponding values of the left and right selected regions in the range are added by 1 and updated to be [1, 2], that is, the second and third sub-data blocks under the second data block B1 are the referenced data blocks.

In some embodiments, if the target operation moves the referenced data block in the first data block, the associated data block of the selected region is kept unchanged; and on the basis of a relative position relationship between the moved referenced data block and other sub-data blocks of the first data block, the range of the selected region is re-determined. In this embodiment, if the user moves the referenced data block in the first data block, a parent data block of the referenced data block is not changed, so that the associated data block of the selected region does not need to be changed, and the range of the selected region can be re-determined on the basis of the position of the moved referenced data block.

The inventor found that a real-time reference function provided by related online document technologies is not perfect, which easily causes the problem of loss of a referenced part. For example, when the user moves or drags contents referenced by other online documents in the online documents, the referenced contents are lost in the other online documents. This is because a section of continuous contents is often considered to be deleted in the original document when being dragged.

In this regard, according to one or more embodiments of the present disclosure, the positions and the ranges of the referenced data blocks are described through the associated data block of the selected region and the range of the selected region, and when the target operation is performed on the associated data block of the selected region, the associated data block and/or the range of the selected region are/is re-determined according to the target operation, so that the synchronous updating of the referenced data blocks can be realized by synchronously updating the associated data block and/or the range of the selected region to update the reference relationship between the data block and the referenced document.

In some embodiments, the target operation includes a first operation instruction, or the first operation instruction and a second operation instruction; the first operation instruction is used for editing a first data block; the second operation instruction is used for editing other data blocks other than the first data block; and the first operation instruction is implemented before the second operation instruction.

Exemplarily, the first operation instruction is used for deleting at least one sub-data block of the first data block; and the second operation instruction is used for inserting at least one sub-data block into the other data blocks other than the first data block.

In one specific implementation, the target operation includes a dragging operation, and the dragging operation is used for dragging one or more sub-data blocks under the first data block to be under the other data blocks other than the first data block. The dragging operation can be to delete the one or more sub-data blocks in the first data block and insert the one or more sub-data blocks to be under the other data blocks.

In some embodiments, step S140 includes:
step A10: determining an initial updating range of the selected region on the basis of the first operation instruction; and
step A21: if the initial updating range of the selected region is determined to be null on the basis of the first operation instruction, and a parent data block of a referenced data block deleted from the first data block is determined to be changed into other data blocks other than the first data block, using the parent data block containing the largest number of referenced data blocks deleted from the first data block as a new associated data block of the selected region, and determining a final range of the selected region according to the second operation instruction for the new associated data block.

In this embodiment, if the initial updating range of the selected region is determined to be null on the basis of the first operation instruction, the first operation instruction deletes all referenced data blocks under the first data block; if it is further determined that the parent data block of the referenced data blocks deleted from the first data block is changed into other data blocks other than the first data block, it means that the referenced data blocks deleted from the first data block are actually possibly dragged by the user to the other data blocks. Therefore, the final range of the selected region can be determined by further re-determining the parent data block containing the largest number of deleted referenced data blocks as the new associated data block of the selected region and on the basis of the second operation instruction for the new associated data block. Exemplarily, the range of the selected region can be re-determined according to the relative position relationship between the deleted referenced data blocks under the new associated data block and other sub-data blocks of the new associated data block.

In some embodiment, step S140 includes:
step A22: if the initial updating range of the selected region is determined to be not null on the basis of the first operation instruction, or the parent data block of the referenced data block deleted from the first data block is determined not to be changed into other data blocks other than the first data block, using the initial updating range as the final range of the selected region.

In this embodiment, if the initial updating range of the selected region is determined not to be null on the basis of the first operation instruction, or the parent data block of the referenced data block deleted from the first data block is determined not to be changed into other data blocks other than the first data block, it is means that the referenced data block under the first data block is not dragged by the user but is possibly directly deleted by the user, and then the initial updating range of the selected region determined on the basis of the first operation instruction can be directly used as the final range of the selected region.

Preferably, the “referenced data block deleted from the first data block” in step A21 and step A22 can be further “a referenced data block which is continuously deleted from the first data block finally”. Generally, an operation instruction generated by the dragging operation of the user may involve two data blocks, for example, when the user drags one or more sub-data blocks from the data block A to the data block B, the dragging operation may continuously trigger an instruction of continuously deleting one or more sub-data blocks from the data block A, and an instruction of continuously inserting one or more sub-data blocks from the data block B, so that if the sub-data blocks of the data block A are subjected to the dragging operation, the operation instruction which is performed on the data block A finally is to continuously deleting one or more sub-data blocks. This is because the next operation instruction is a data block insertion instruction for the data block B. Therefore, in this embodiment, whether the referenced data blocks are subjected to the dragging operation by the user can be determined more accurately by determining whether the parent data block of the referenced data block which is continuously deleted from the first data block finally is changed.

In a specific implementation, the operation instructions for the data blocks can be recorded according to a time sequence, whether one or more operation instructions which are last continuously performed for the first data block are the deletion operation instructions is determined, and whether the parent data block of the referenced data block deleted according to the deletion operation instructions is changed into other data blocks other than the first data block is determined, and thus whether the parent data block of the referenced data block which is last continuously deleted from the first data block is changed into other data blocks other than the first data block can be determined.

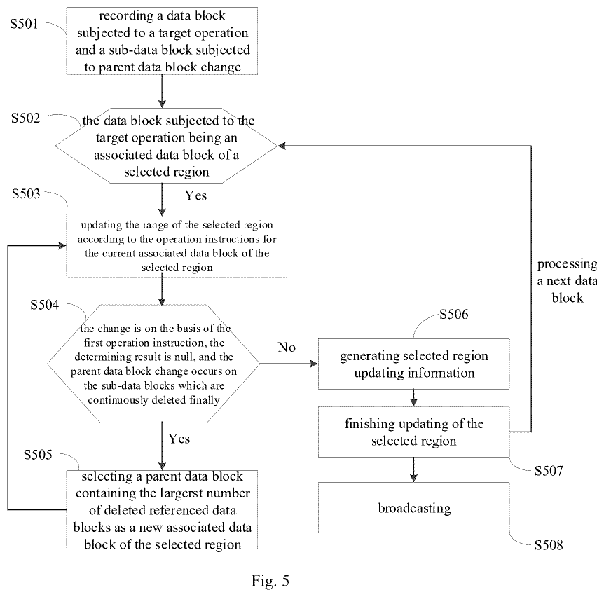

Referring FIG. 5, FIG. 5 shows a flowchart of a method 500 for controlling a data block according to an embodiment of the present disclosure, and the method 500 includes:

Step S501: Recording a data block subjected to a target operation and a sub-data block subjected to parent data block change.

Step S502: Determining whether the data block subjected to the target operation is an associated data block of a selected region.

If the data block subjected to the target operation is the associated data block of the selected region, step S503 is executed, which includes, updating the range of the selected region according to the target operation for the current associated data block of the selected region.

If the data block subjected to the target operation is not the associated data block of the selected region, the next data block is processed without updating the associated node and the range of the selected region.

Step S504: Determining whether the updating of the range of the selected region in step S503 is on the basis of the first operation instruction, whether the determining result is null, and whether the parent data block change occurs on the sub-data blocks which are continuously deleted finally.

If the judgement results in step S504 are all yes, step S505 is executed, which includes, selecting a parent data block containing the largest number of deleted referenced data blocks as a new associated data block of the selected region.

After the step S505 is finished, the step S503 can be executed again. Those skilled in the art can understand that in this embodiment, the step S503 executed for the first time is to update the range of the selected region on the basis of the first operation instruction for the initial associated data block of the selected region; and the step S503 executed again is to update the range of the selected region on the basis of the target operation (such as the second operation instruction) for the new associated data block of the selected region.

After the step S503 is executed again, the judgement results in the step S504 will be no, the step S506 is executed, which includes, determining selected region updating information on the basis of the re-determined associated data block and/or range of the selected region.

Step S507: Finishing updating of the selected region.

Step S508: Broadcasting the selected region updating information.

In some embodiments, the range of the selected region is described with a left end point and a right end point; and the step S140 includes: if the target operation is used for adding or deleting N data blocks on the left side of the left end point under the current associated data block of the selected region, increasing or decreasing the corresponding numerical values of the left end point and the right end point of the selected region by N; or, if the target operation is used for adding or deleting N data blocks on the right side of the right end point under the current associated data block of the selected region, keeping the corresponding numerical values of the left end point and the right end point unchanged; or, if the target operation is used for adding or deleting N data blocks between the left end point and the right end point under the current associated data block of the selected region, increasing or decreasing the corresponding numerical value of the right end point of the selected region by N, and keeping the corresponding numerical value of the left end point unchanged, N being a positive integer.

Examples are provided below for description. It is assumed that the data block A1 has the sub-data blocks A2, B2, C2 and D2 which respectively correspond to index arrays {0, 1, 2, 3}, and if the data blocks B2 and C2 are the referenced data blocks, the associated data block of the selected region S is A1, and the range of the selected region S is [1, 2]; if the user inserts or deletes N data blocks on the left side of the left end point of the selected region, namely before the data block B2, the selected region is integrally moved backwards or forwards by N positions, namely the values of the left and right end points of the selected region are added by N or subtracted by N; if the user inserts or deletes N data blocks on the right side of the right end point of the selected region, namely after the data block C2, the values of the left and right end points of the selected region are not changed; and if the user adds or deletes N data blocks between the left and right end points, the range of the selected region is [1, 2±N].

In some embodiments, the step S140 further includes: if the target operation is used for adding N data blocks at any end point of the selected region in the original document, keeping the range of the selected region changed; or, if the target operation is used for adding N data blocks at the right end point of the selected region in the reference, increasing all the corresponding numerical values of the right end point of the selected region by N, and keeping the corresponding numerical value of the left end point unchanged; or, if the target operation is used for adding N data blocks on the left end point side of the selected region in the reference, increasing the corresponding numerical values of the left end point and the right end point of the selected region by N, the reference being the online document referencing one or more data blocks of the original document.

Referring FIG. 2, when a certain user adds new data blocks at the left and right end points of the selected region in the second online document 220 serving as the reference document, the intention of the user is often to increase the range of the referenced data blocks at a critical point, and particularly, the user editing the reference document is often the user referencing the data blocks. However, when a certain user adds new data blocks at the left and right end points (data blocks 11 and 12) of the selected region in the first online document 210 serving as the original document, the intention of the user at the moment may be not to increase the referenced data blocks but process other data blocks because other data blocks are still adjacent to the front and back of the referenced data blocks, and particularly, the user editing the original document may not the user referencing the data blocks. Therefore, according to one or more embodiments of the present disclosure, when the user inserts the data blocks at the end points of the selected region in the reference, the range of the selected region is correspondingly expanded; and when the user adds the data blocks at the end points of the selected region in the original document, the data blocks are not used as the new referenced data blocks, so that synchronous referencing updating more conforming to the intention of the user can be realized.

In some embodiments, if the user drags the referenced data block in the reference document, the associated node and range of the selected region are not changed, that is, the referenced data block in the original document is kept unchanged; and if the user inserts the data blocks in the selected region in the reference document, the range of the selected region can be changed, that is, the referenced data block in the original document is correspondingly changed. As shown in FIG. 2, if the user drags the data blocks A2 and B2 in the second online document 220, the data blocks A2 and B2 in the first online document 210 are not changed; and if the user inserts a new data block X2 between the data blocks A2 and B2 in the second online document 220, a new data block is correspondingly inserted between the data blocks A2 and B2 in the first online document 210.

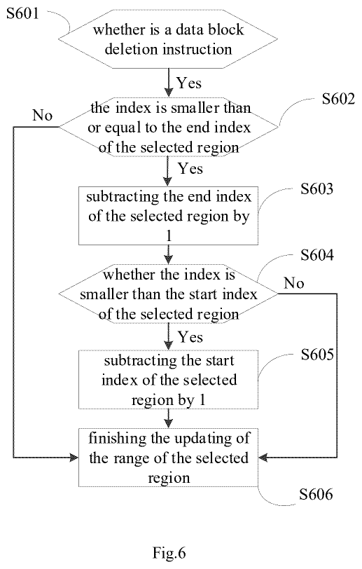

Referring FIG. 6, FIG. 6 shows a flowchart of a method for determining a range of a selected region on the basis of a target operation according to the present disclosure. The method 600 includes steps S601-S610.

Step S601: Determining whether the target operation for the associated data block of the selected region includes a data block deletion instruction, the data block deletion instruction being used for deleting the data block at the index. Exemplarily, the data block insertion instruction can be an instruction {p:[path,idx], ld:obj}, and the index can be a numerical value corresponding to the “idx” in the instruction.

Step S602: Determining whether the index is smaller than or equal to the end index of the selected region.

If the index is smaller than or equal to the end index of the selected region (namely, index≤end, end represents the end index of the selected region), the step S603 is executed, which includes, subtracting the end index of the selected region by 1 (namely, end=end−1).

If the index is greater than the end index of the selected region (namely, index> end), the step S606 is executed, which includes, finishing updating of the range of the selected region. In this step, because the index corresponding to the deletion instruction is greater than the end index of the selected region, it means that the deletion instruction for the data blocks is used for deleting the data block on the right side of the right boundary of the selected region, the range of the selected region is not affected, and the selected region does not need to be updated.

Step S604: Determining whether the index is smaller than the start index of the selected region.

If the index is smaller than the start index of the selected region (namely index<start, start represents the start index of the selected region), the step S605 is executed which includes, subtracting the start index of the selected region by 1 (namely start=start−1). In this step, because the index corresponding to the deletion instruction is smaller than the start index of the selected region, it means that the deletion instruction for the data blocks is used for deleting the data blocks on the left side of the left boundary of the selected region, equivalently, one data block is subtracted from the data blocks on the left side of the selected region, and therefore the whole selected region needs to be moved to the left side by one position, namely the start index and the end index of the selected region are both subtracted by 1 finally.

If the index is greater than or equal to the start index of the selected region (namely index≥start), the step S606 is executed, which includes, finishing the updating of the range of the selected region. In this step, because the index corresponding to the deletion instruction is greater than or equal to the start index of the selected region and smaller than or equal to the end index of the selected region (namely start≤index≤end), it means that the deletion instruction for the data blocks is the deletion instruction for the data blocks in the selected region, and therefore, the start index of the selected region is not changed, only the end index is subtracted by 1, that is, the range of the selected region is reduced finally.

Examples are provided below for description. It is assumed that the data block A1 has the sub-data blocks A2, B2, C2 and D2 which respectively correspond to index arrays {0, 1, 2, 3}; and if the data blocks B2 and C2 are the referenced data blocks, the associated data block of the selected region S is A1, the range of the selected region S is [1, 2], that is, the start index of the selected region is 1 (namely start=1, corresponding to the data block B2), and the end index is 2 (namely end=2, corresponding to the data block C2). If the index of the data block deletion instruction is 0 (namely index=0), that is, the deletion instruction is used for deleting the data block A2, and because index≤end and index<start, the selected region is integrally moved forwards, and the range is updated to be [0, 1], respectively corresponding to the data blocks B2 and C2 after forward movement; if the index of the data block deletion instruction is 1 (namely index=1), that is, the deletion instruction is used for deleting the referenced data block B2, and because start≤index≤end, the range of the selected region is updated to be [1, 1], corresponding to the data block C2 after forward movement; if the index of the data block deletion instruction is 2 (namely index=2), that is, the deletion instruction is used for deleting the referenced data block C2, and because start≤index≤end, the range of the selected region is updated to be [1, 1], corresponding to the data block B2 which is not moved; and if the index of the data block deletion instruction is 3 (namely index=3), that is, the deletion instruction is used for deleting the data block D2, and because index>end, the range of the selected region does not need to be updated, and the range is still [0, 1].

It is should be noted that the data block deletion instruction in one or more of the foregoing embodiments is concerned on deleting one data block, and those skilled in the art may understand that a plurality of data blocks can be deleted by means of sequentially deleting the plurality of data blocks through a plurality of deletion instructions (such as circulating the above steps S601-S606), or deleting a plurality of data blocks by one deletion instruction, etc., which is not limited here in the present disclosure.

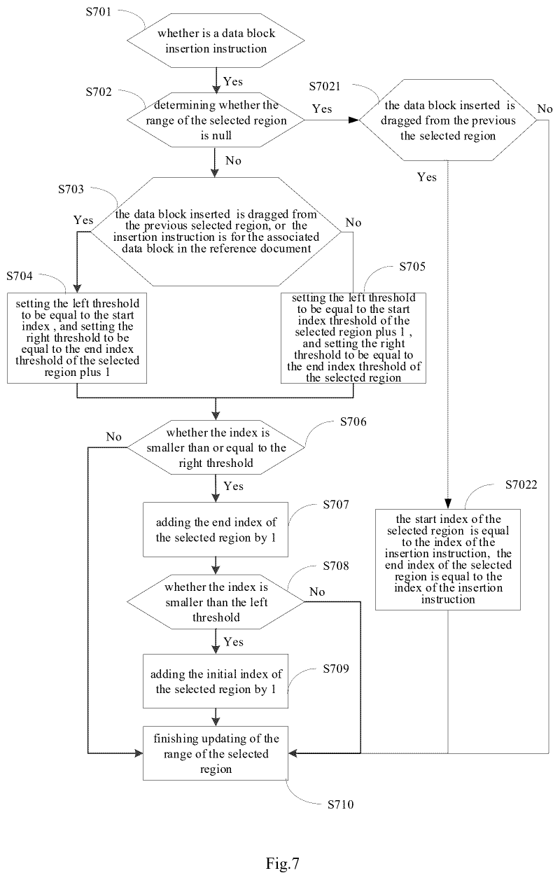

Referring FIG. 7, FIG. 7 shows a flowchart of a method for determining a range of a selected region on the basis of a target operation according to the present disclosure. The method 700 includes steps S701-S710.

Step S701: Determining whether the target operation on the associated data block of the selected region includes a data block insertion instruction, the data block insertion instruction being used for inserting the data block at the index. Exemplarily, the data block insertion instruction can be an instruction {p:[path,idx], li:obj}, and the index can be a numerical value corresponding to the “idx” in the instruction.

Step S702: Determining whether the range of the selected region is null. Exemplarily, when the end index of the selected region is smaller than the start index, the range of the selected region is null.

If the selected region is determined to be null in the step S702, the step S7021 is executed, which includes, determining whether the data block inserted according to the insertion instruction is the referenced data block dragged from the previous associated data block of the selected region, the previous associated data block of the selected region being an associated data block before the associated data block of the selected region is updated. That is, this step is used for judging the inserted data block is the data block dragged from the previous selected region.

If the judgement in the step S7021 is yes, the step S7022 is executed, which includes, the start index of the selected region being the index (start=index), and the end index of the selected region being the index (end=index).

If the judgement in the step S7021 is no, the step S710 is executed, which includes, finishing the updating of the range of the selected region. In this embodiment, if the judgement is no, it means that the data block inserted according to the current insertion instruction is not the referenced data block dragged by the user from the previous associated data block of the selected region, the range of the selected region does not need to be updated.

If the range of the selected region is determined to be not null in the step S702, the step S703 is executed, which includes, determining whether the data block inserted according to the insertion instruction is the referenced data block dragged from the previous associated data block of the selected region, or whether the data block insertion instruction is for the associated data block in the reference document.

The reference document is an online document referring the referenced data block. In some embodiments, FIG. 2 is taken as an example for description, the sub-data blocks 11 and 12 under the first data block 10 of the first online document 210 are referenced by the second online document 220, the second online document is the “reference document” in step S703, and step S703 is used for determining whether the data block insertion instruction is an instruction acting on a parent data block where the referenced data block in the second online document is located.

If the judgement result in step S703 is yes, step S704 is executed, which includes, setting the left threshold (left) to be equal to the start index (start) (namely left=start) of the selected region, and setting the right threshold (right) to be equal to the end index threshold of the selected region plus 1 (namely right=end+1) of the selected region.

If the judgement result in step S703 is no, step S705 is executed, which includes, setting the left threshold (left) to be equal to the start index threshold (start) of the selected region plus 1 (namely left=start+1), and setting the right threshold (right) to be equal to the end index threshold (namely right=end) of the selected region.

Step S706: Determining whether the index is smaller than or equal to the right threshold.

If the index is smaller than or equal to the right threshold (namely index≤right), step S707 is executed, which includes, adding the end index of the selected region by 1 (namely end=end+1); and
if the index is greater than the right threshold (namely index>right), other steps are skipped and step S710 is directly executed, which includes: finishing the updating of the range of the selected region. In this embodiment, because the index is greater than the right threshold, the insertion instruction is considered as to insert the data block into the right side of the right end point of the selected region, and the range of the selected region does not need to be updated.

Step S708: Determining whether the index is smaller than the left threshold.

If the index is smaller than the left threshold (namely, index≤left), step S709 is executed, which includes, adding the initial index of the selected region by 1 (namely, start=start+1). In this embodiment, if the index is smaller than the left threshold, the insertion instruction is considered as to insert the data block into the left side of the left end point of the selected region, so that the 1 is correspondingly added to final left and right interval values of the selected region.

If the index of the insertion instruction is greater than or equal to the left threshold (index≥left), step S709 is executed, which includes, adding the initial index of the selected region by 1 (namely, start=start+1). In this step, if the index is greater than or equal to the left threshold, the insertion instruction is considered as to insert the data block into the range of the selected region, so that the left interval value of the final selected region is not changed, and the 1 is added to the right interval value.

Step S710: Finishing updating of the range of the selected region.

According to one or more embodiments of the present disclosure, different left and right thresholds are set for the insertion instructions for different types of data blocks, and the left and right thresholds can represent a “fictive” region of the selected region (the left and right thresholds can correspond to left and right intervals respectively); the insertion instruction for the associated data block in the reference document (or the dragged referenced data block is inserted into the end point of the selected region) is compared with the insertion instruction in the original document, the result shows that an interval range (namely [start, end+1]) formed by the corresponding left and right thresholds of the previous insertion instruction is expanded by one unit left and right compared with the interval range (namely [start+1, end]) formed by the left and right thresholds corresponding to the latter insertion instruction in the original document. Therefore, when the user inserts the data block into the end point of the selected region in the reference document (or the dragged referenced data block is inserted into the end point of the selected region), the insertion is considered to be performed in the selected region, so that the range of the selected region can be correspondingly expanded; and when the user adds the data block into the end point of the selected region in the original document, the data block is not used as the new referenced data block, so that the synchronous updating of the referenced data block more conforming to the intention of the user can be realized.

In some embodiments, step S140 includes:
C1: if the target operation is used for dragging the referenced data block under the first data block to be parallel to the first data block, creating a new data block as the parent data block of the dragged referenced data block, the new data block and the first data block having a common parent data block;
C2: updating the associated data block of the selected region to be the new data block; and
C3: on the basis of the number of the referenced data blocks dragged to the new data block by the target operation, updating the range of the selected region.

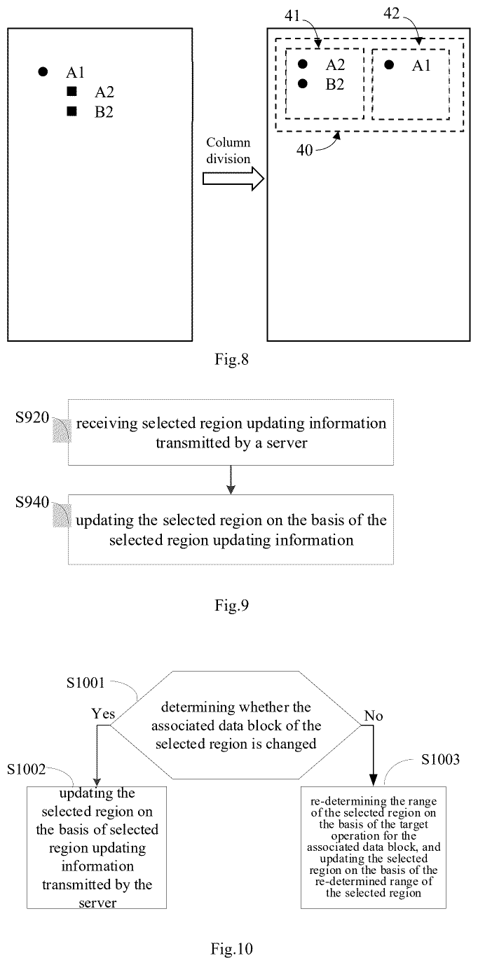

As shown in FIG. 8, the user can make the sub-data blocks A2 and B2 under the data block A1 to be parallel to the data block A1 through a column division operation, so that the data blocks A2 and B2 and the data block A1 belong to two different columns. According to one or more embodiments of the present disclosure, the data block 41 can be created as the parent data block of the data blocks A2 and B2 after column division, and the parent data blocks 42 of the data blocks 41 and A1 have a common parent data block 40. If the sub-data blocks A2 and B2 are the referenced data blocks, the associated data block of the selected region can be updated from the data block A1 to be the data block 41, and the range of the selected region is updated on the basis of the number of the referenced data blocks under the data block 41. In this embodiment, the range of the selected region is originally [0, 1], and the range of the updated selected region is still [0, 1]. In one specific embodiment, the user can drag the data blocks A2 and B2 to the left side or the right side of the parent data block thereof to realize left and right column division of the dragged data block and the original parent data block thereof.

According to one or more embodiments of the present disclosure, a method for controlling a data block is provided and includes:
B1: Determining a referenced data block in a first document, the referenced data block having a reference relationship with a second document.
B2: In response to a target operation being performed on the referenced data block, change the position of the referenced data block in the first document.
B3: In response to the position of the referenced data block being changed in the first document, keeping the reference relationship between the second document and the referenced data block.

In this embodiment, the reference relationship between the referenced data block and the second document is that the second document references the referenced data block.

In some embodiments, the referenced data block is a data block or a group of continuous data blocks.

In some embodiments, the target operation includes a dragging operation which is used for moving the data block. Exemplarily, the dragging operation can move sub-data blocks in the data block or move the sub-data blocks among the data blocks, for example, the dragging operation can delete one or more sub-data blocks in the first data block and insert the one or more sub-data blocks to be under other data blocks.

The inventors found that problem that real-time reference function provided by related online document technologies is not perfect, which easily causes the problem of loss of the referenced part. For example, when the user moves or drags the content referenced by other online documents in the online documents, the referenced contents are often lost in the other online documents, it is because a section of continuous content is often considered to be deleted in the original document when dragged.

Therefore, according to one or more embodiments of the present disclosure, the reference relationship between the second document and the referenced data block is kept while the position of the referenced data block is changed by the target operation, so that the reference relationship between the data block and the document is prevented from being interrupted due to the movement of the data block.

In some embodiments, the positions and ranges of the referenced data blocks are described by the associated data block of the selected region and range of the selected region; and the associated data block of the selected region is the parent data block of the referenced data block.

In some embodiments, step B3 includes: re-determining the associated data block and/or range of the selected region on the basis of the target operation.

The way of setting the selected region or specific implementations of re-determining the associated data block and/or range of the selected region on the basis of the target operation may refer to the above description, which is not repeated here.

Correspondingly, as shown in FIG. 9, a method for controlling a data block is provided according to an embodiment of the present disclosure and includes:

Step S920: Receiving selected region updating information transmitted by a server, the selected region updating information being determined by the server on the basis of the following steps: in response to a target operation being performed on a first data block, determining whether the first data block is an associated data block of the selected region; in response to the first data block being determined to be the associated data block of the selected region, re-determining the associated data block and/or range of the selected region on the basis of the target operation; and determining the selected region updating information on the basis of the re-determined associated data block and/or range of the selected region, the selected region being organized to describe the position and range of a referenced data block through the associated data block of the selected region and the range of the selected region, and the referenced data block being a data block referenced by at least one online document.

Step S940: Updating the selected region on the basis of the selected region updating information.

As shown in FIG. 10, a method for controlling a data block is provided according to an embodiment of the present disclosure and includes steps S1001-S1003:

Step S1001: Determining whether the associated data block of the selected region is changed.

If the associated data block of the selected region is changed, step S1002 is executed, which includes: updating the selected region on the basis of selected region updating information transmitted by the server. Exemplarily, the selected region updating information can be polled from the server and the selected region is updated on the basis of the selected region updating information.

If the associated data block of the selected region is not changed, step S1003 is executed, which includes, re-determining the range of the selected region on the basis of the target operation for the associated data block, and updating the selected region on the basis of the re-determined range of the selected region.

In some embodiments, if the judgement result in step S1003 is null, step S1002 is executed, namely, when a client determines that the range of the selected region is null on the basis of the target operation, the selected region updating information of the server is directly polled away to update the selected region.

According to one or more embodiments of the present disclosure, when the target operation does not change the associated data block of the selected region, it means that the target operation is only to edit in the associated data block, such as inserting and deleting sub-data blocks. In this case, the client can update the range of the selected region without completely depending on the selected region updating information pushed by the server, so that the timeliness and consistency of synchronous referencing can be improved.

It is to be noted that the embodiment of the client basically corresponds to the embodiment of the server, so related parts refer to partial description of the method embodiment, which is not repeated here.

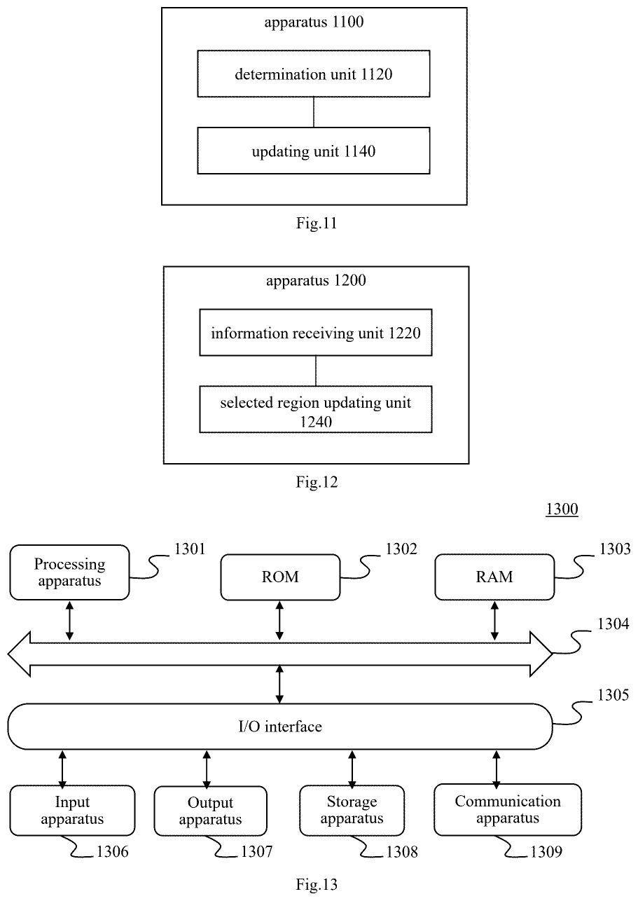

Correspondingly, as show in FIG. 11, an apparatus 100 for controlling a data block is provided according to an embodiment of the present disclosure and includes:
a determination unit 1120, configured to, in response to a target operation being performed on a first data block in a first document, determine whether the first data block has a reference relationship with a second document, the target operation being used for inserting, deleting, moving or replacing sub-data blocks under the data blocks; and
an updating unit 1140, configured to, in response to the first data block having the reference relationship with the second document, update the reference relationship between at least one data block in the first document and the second document on the basis of the target operation.

In some embodiments, the apparatus 1100 further includes:
an information generation unit, configured to determine selected region updating information on the basis of the re-determined associated data block and/or range of the selected region;
an information transmission unit, configured to transmit the selected region updating information to a client, so that the client can update the selected region on the basis of the selected region updating information.

In some embodiments, an apparatus for controlling a data block is provided and includes:
a referenced data block determination unit, configured to determine a referenced data block in a first document, the referenced data block having a reference relationship with a second document;
a position changing unit, configured to, in response to a target operation being performed on the referenced data block, change the position of the referenced data block in the first document; and
a referencing unit, configured to, in response to the position of the referenced data block being changed in the first document, keep the reference relationship between the second document and the referenced data block.

Correspondingly, as shown in FIG. 12, an apparatus 1200 for controlling a data block is provided according to an embodiment of the present disclosure and includes:
an information receiving unit 1220, configured to receive selected region updating information transmitted by a server, the selected region updating information being determined by the server on the basis of the following steps: in response to a target operation being performed on a first data block, determining whether the first data block is an associated data block of the selected region; in response to the first data block being determined to be the associated data block of the selected region, re-determining the associated data block and/or range of the selected region on the basis of the target operation; determining the selected region updating information on the basis of the re-determined associated data block and/or range of the selected region, the selected region being organized to describe the position and range of a referenced data block through the associated data block of the selected region and the range of the selected region, and the referenced data block being a data block referenced by at least one online document; and
a selected region updating unit 1240, configured to update the selected region on the basis of the selected region updating information.

For the embodiments of the apparatus, since they substantially correspond to the method embodiments, the partial explanation of the method embodiments is referred to for relevant information. The apparatus embodiments described above are only illustrative, and the modules described as separate modules may or may not be separate. Some or all modules can be selected according to actual needs to achieve the purpose of this embodiment. Ordinary technical personnel in this art can understand and implement without creative efforts.

Correspondingly, according to one or more embodiments of the present disclosure, there is provided a system, including: a server with an apparatus 1100 for controlling a data block; and at least one terminal with apparatus 1200 for controlling a data block. Among them, the terminal includes but is not limited to a mobile terminal such as a mobile phone, a laptop, a digital broadcast receiver, PDA (personal digital assistant), PAD (portable Android device), PMP (portable multimedia player), a vehicle-mounted terminal (e.g., a vehicle-mounted navigation terminal), and a fixed terminal such as a digital TV, a desktop computer, and so on. The terminal is connected to the server 402 through the local internet, Wide Area Network or Internet, and the terminal and the server establish a wired connection or wireless connection. The wired connection includes but is not limited to PoE, coaxial cable, optical fiber, USB data connection.

For the embodiment of the system, since it substantially corresponds to the embodiments of the method, the partial explanation of the embodiments of the method is referred to for relevant information.

Correspondingly, according to one or more embodiments of the present disclosure, an electronic device is provided and includes;
at least one memory and at least one processor,
the memory is configured to store program codes, and the processor is configured to call the program codes stored in the memory to enable the electronic device to execute the method for controlling a data block provided by one or more embodiments of the present disclosure.

Correspondingly, according to one or more embodiments of the present disclosure, a non-transient computer storage medium is provided. Program codes are stored in the non-transient computer storage medium; and when the program codes are executed by a computer device, the computer device is enabled to execute the method for controlling a data block provided by one or more embodiments of the present disclosure.

Referring to FIG. 13, FIG. 13 illustrates a schematic structural diagram of an electronic device 1300 (for example) suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 13 is merely an example and should not pose any limitation to the functions and the range of use of the embodiments of the present disclosure.

As illustrated in FIG. 13, the electronic device 1300 may include a processing apparatus 1301 (e.g., a central processing unit, a graphics processing unit, etc.), which can perform various suitable actions and processing according to a program stored in a read-only memory (ROM) 1302 or a program loaded from a storage apparatus 508 into a random-access memory (RAM) 1303. The RAM 1303 further stores various programs and data required for operations of the electronic device 1300. The processing apparatus 1301, the ROM 1302, and the RAM 1303 are interconnected by means of a bus 1304. An input/output (I/O) interface 1305 is also connected to the bus 1304.

Usually, the following apparatus may be connected to the I/O interface 1305: an input apparatus 1306 including, for example, a touch screen, a touch pad, a keyboard, a mouse, a camera, a microphone, an accelerometer, a gyroscope, or the like; an output apparatus 1307 including, for example, a liquid crystal display (LCD), a loudspeaker, a vibrator, or the like; a storage apparatus 1308 including, for example, a magnetic tape, a hard disk, or the like; and a communication apparatus 1309. The communication apparatus 1309 may allow the electronic device 1300 to be in wireless or wired communication with other devices to exchange data. While FIG. 13 illustrates the electronic device 1300 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 1309 and installed, or may be installed from the storage apparatus 1308, or may be installed from the ROM 1302. When the computer program is executed by the processing apparatus 1301, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP) and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device or may also exist alone without being assembled into the electronic device.

The above-mentioned computer-readable medium carries one or more programs, and when the one or more programs are executed by the electronic device, the electronic device is caused to execute the above methods of the present disclosure.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, a method for controlling a data block, including: in response to a target operation being performed on a first data block in a first document, determining whether the first data block has a reference relationship with a second document, wherein the target operation is used for inserting, deleting, moving or replacing a sub-data block under a data block; and in response to the first data block being determined to have the reference relationship with the second document, updating the reference relationship between at least one data block in the first document and the second document on the basis of the target operation.

According to one or more embodiments of the present disclosure, the updating the reference relationship between at least one data block in the first document and the second document on the basis of the target operation includes: updating the reference relationship between the first data block and the second document on the basis of the target operation; if all or a largest number of referenced data blocks referenced by the second document under the first data block are moved according to the target operation to be under the second data block in the first document, the updating the reference relationship between at least one data block in the first document and the second document on the basis of the target operation further includes: determining the reference relationship between the second data block and the second document on the basis of the target operation.

According to one or more embodiments of the present disclosure, the updating the reference relationship between the first data block and the second document on the basis of the target operation includes: updating the reference relationship between the first data block and the second document on the basis of a relative position relationship between the data block targeted by the target operation and other sub-data blocks of the first data block under the first data block.

According to one or more embodiments of the present disclosure, the determining the reference relationship between the second data block and the second document on the basis of the target operation includes: determining the reference relationship between the second data block and the second document on the basis of a relative position relationship between the referenced data block moved to be under the second data block by the target operation and other sub-data blocks of the second data block.

According to one or more embodiments of the present disclosure, the determining whether the first data block has a reference relationship with a second document includes: determining whether the first data block is an associated data block of a selected region; the determining the reference relationship between at least one data block in the first document and the second document on the basis of the target operation includes: in response to the first data block is selected as the associated data block of the selected region, re-determining the associated data block and/or a range of the selected region on the basis of the target operation, wherein the selected region is organized to describe a position and range of the referenced data block through the associated data block of the selected region and the range of the selected region; and the referenced data block is a data block referenced by at least one online document.

According to one or more embodiments of the present disclosure, the re-determining the associated data block of the selected region on the basis of the target operation includes: in response to that all or a largest number of the referenced data blocks under the first data block are moved to be under the second data block by the target operation, changing the associated data block of the selected region from the first data block to the second data block.

According to one or more embodiments of the present disclosure, the re-determining the range of the selected region on the basis of the target operation includes: re-determining the range of the selected region, on the basis of the relative position relationship between the referenced data block moved to be under the second data block by the target operation and other sub-data blocks of the second data block.

According to one or more embodiments of the present disclosure, the re-determining the associated data block and/or range of the selected region on the basis of the target operation includes: if the target operation is used for moving the referenced data blocks in the first data block, keeping the associated data block of the selected region unchanged; and re-determining the range of the selected region, on the basis of the relative position relationship between the moved referenced data blocks and other sub-data blocks of the first data block.

According to one or more embodiments of the present disclosure, the target operation is used for triggering a first operation instruction or triggering the first operation instruction and a second operation instruction; and the first operation instruction is used for editing the first data block, and the second operation instruction is used for editing other data blocks other than the first data block.

According to one or more embodiments of the present disclosure, the re-determining the associated data block and/or range of the selected region on the basis of the target operation includes: determining an initial updating range of the selected region on the basis of the first operation instruction; and if the initial updating range of the selected region is determined to be null on the basis of the first operation instruction, and a parent data block of the referenced data block deleted from the first data block is determined to be changed into other data blocks other than the first data block, using the parent data block containing the largest number of referenced data blocks deleted from the first data block as a new associated data block of the selected region, and determining a final range of the selected region according to the second operation instruction for the new associated data block.

According to one or more embodiments of the present disclosure, the re-determining the associated data block and/or range of the selected region on the basis of the target operation includes: if the initial updating range of the selected region is determined to be not null on the basis of the first operation instruction, or the parent data block of the referenced data block deleted from the first data block is determined as not changing into other data blocks other than the first data block, using the initial updating range as the final range of the selected region.

According to one or more embodiments of the present disclosure, the first operation instruction is used for deleting at least one sub-data block of the first data block, and the second operation instruction is used for inserting at least one sub-data block into other data blocks other than the first data block.

According to one or more embodiments of the present disclosure, the target operation includes a dragging operation for data blocks.

According to one or more embodiments of the present disclosure, the range of the selected region has a left end point and a right end point, and the re-determining the range of the selected region on the basis of the target operation includes: if the target operation is used for adding or deleting N data blocks on a left side of the left end point of the selected region, increasing or decreasing corresponding numerical values of the left end point and the right end point of the selected region by N; or if the target operation is used for adding or deleting N data blocks on a right side of the right end point of the selected region, keeping the corresponding numerical values of the left end point and the right end point unchanged; or if the target operation is used for adding or deleting N data blocks between the left end point and the right end point of the selected region, increasing or decreasing the corresponding numerical value of the right end point of the selected region by N, and keeping the corresponding numerical values of the left end point unchanged, wherein N is a positive integer.

According to one or more embodiments of the present disclosure, the re-determining the range of the selected region on the basis of the target operation includes: if the target operation is used for increasing N data blocks to any end point of the selected region in an original document, keeping the range of the selected region unchanged; or if the target operation is used for increasing N data blocks to the right end point of the selected region in a reference document, increasing all of the corresponding numerical values of the right end point of the selected region by N, and keeping the corresponding numerical values of the left end point of the selected region unchanged; or if the target operation is used for increasing N data blocks to the left end point of the selected region in the reference document, increasing all of the corresponding numerical values of the left end point and the right end point of the selected region by N, wherein the reference document is an online document which references one or more data blocks of the original document.

According to one or more embodiments of the present disclosure, the re-determining the associated data block and/or range of the selected region on the basis of the target operation includes: if the target operation is used for dragging the referenced data block under the first data block to be parallel to the first data block, creating a new data block as the parent data block of the dragged referenced data block; updating the associated data block of the selected region to be the new data block, wherein the new data block and the first data block have a common parent data block; and updating the range of the selected region, on the basis of the number of the referenced data blocks dragged to be under the new data block by the target operation.

According to one or more embodiments of the present disclosure, the target operation includes a column division operation.

According to one or more embodiments of the present disclosure, the method further includes: determining selected region updating information on the basis of the re-determined associated data block and/or range of the selected region; and transmitting the selected region updating information to a client, thereby enabling the client to update the selected region on the basis of the selected region updating information.

According to one or more embodiments of the present disclosure, a method for controlling a data block is provided, and includes: determining a referenced data block in a first document, the referenced data block having a reference relationship with a second document; in response to a target operation being performed on the referenced data block, changing a position of the referenced data block in the first document; and in response to the position of the referenced data block being changed in the first document, keeping the reference relationship between the second document and the referenced data block.

According to one or more embodiments of the present disclosure, the position and range of the referenced data block are described through the associated data block of the selected region and the range of the selected region; and the associated data block of the selected region is a parent data block of the referenced data block.

According to one or more embodiments of the present disclosure, the keeping the reference relationship between the second document and the referenced data block includes: re-determining the associated data block and/or the range of the selected region on the basis of the target operation, so as to keep the reference relationship between the second document and the referenced data block.

According to one or more embodiments of the present disclosure, the target operation includes a dragging operation.

According to one or more embodiments of the present disclosure, a method for controlling a data block is provided, and the method is applied to a client and includes: receiving selected region updating information transmitted by a server, the selected region updating information being determined by a server on the basis of the following steps: in response to a target operation being performed on a first data block, determining whether the first data block is an associated data block of a selected region; in response to the first data block being determined to be the associated data block of the selected region, re-determining the associated data block and/or range of the selected region on the basis of the target operation; determining the selected region updating information on the basis of the re-determined associated data block and/or range of the selected region, wherein the selected region is organized to describe a position and range of a referenced data block through the associated data block of the selected region and the range of the selected region, and the referenced data block is a data block referenced by at least one online document; and updating the selected region on the basis of the selected region updating information.

According to one or more embodiments of the present disclosure, before updating the selected region on the basis of the selected region updating information, the method further includes: determining whether the associated node of the selected region is changed; if the associated node of the selected region is not changed, re-determining the range of the selected region on the basis of the target operation for the associated node, and updating the selected region on the basis of the re-determined range of the associated data block of the selected region; and if the associated node of the selected region is changed, performing the step of updating the selected region on the basis of selected region updating information.

According to one or more embodiments of the present disclosure, the method further includes: if the range of the associated data block re-determined on the basis of the target operation is null, performing the step of updating the selected region on the basis of the selected region updating information.

According to one or more embodiments of the present disclosure, an apparatus for controlling a data block is provided, and the apparatus includes: a determination unit, configured to, in response to a target operation being performed on a first data block in a first document, determine whether the first data block has a reference relationship with a second document, wherein the target operation is used for inserting, deleting, moving or replacing a sub-data block under a data block; and an updating unit, configured to, in response to the first data block having the reference relationship with the second document, update the reference relationship between at least one data block in the first document and the second document on the basis of the target operation.

According to one or more embodiments of the present disclosure, an apparatus for controlling a data block is provided, and the apparatus includes: a referenced data block determination unit, configured to determine a referenced data block in a first document, the referenced data block having a reference relationship with a second document; a position changing unit, configured to, in response to a target operation being performed on the referenced data block, change a position of the referenced data block in the first document; and a referencing unit, configured to, in response to the position of the referenced data block being changed in the first document, keep the reference relationship between the second document and the referenced data block.

According to one or more embodiments of the present disclosure, an apparatus for controlling a data block is provided and includes: an information receiving unit, configured to receive selected region updating information transmitted by a server, the selected region updating information being determined by the server on the basis of the following steps: in response to a target operation being performed on a first data block, determining whether the first data block is an associated data block of the selected region; in response to the first data block being determined to be the associated data block of the selected region, re-determining the associated data block and/or range of the selected region on the basis of the target operation; determining the selected region updating information on the basis of the re-determined associated data block and/or range of the selected region, wherein the selected region is organized to describe the position and range of a referenced data block through the associated data block of the selected region and the range of the selected region, and the referenced data block is a data block referenced by at least one online document; and a selected region updating unit, configured to update the selected region on the basis of the selected region updating information.

According to one or more embodiments of the present disclosure, an electronic device is provided, and includes: at least one memory and at least one processor. The memory is configured to store program codes, and the processor is configured to call the program codes stored in the memory to enable the electronic device to execute the method for controlling a data block provided by one or more embodiments of the present disclosure.

According to one or more embodiments of the present disclosure, a non-transient computer storage medium is provided. Program codes are stored in the non-transient computer storage medium; and when the program codes are executed by a computer device, the computer device is enabled to execute the method for controlling a data block provided by one or more embodiments of the present disclosure.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for controlling a data block, comprising:
receiving a target operation being performed on a first data block in a first document, wherein the first data block has a reference relationship with a second document, and the target operation comprises inserting, deleting, moving or replacing a sub-data block under the first data block; and
updating the reference relationship between at least one data block in the first document and the second document on the basis of the target operation.

2. The method according to claim 1, wherein the updating the reference relationship between at least one data block in the first document and the second document on the basis of the target operation comprises: updating the reference relationship between the first data block and the second document on the basis of the target operation;
if all or a largest number of referenced data blocks referenced by the second document under the first data block are moved according to the target operation to be under the second data block in the first document, the updating the reference relationship between at least one data block in the first document and the second document on the basis of the target operation further comprises: determining the reference relationship between the second data block and the second document on the basis of the target operation.

3. The method according to claim 2, wherein the updating the reference relationship between the first data block and the second document on the basis of the target operation comprises:
updating the reference relationship between the first data block and the second document on the basis of a relative position relationship between the data block targeted by the target operation and other sub-data blocks of the first data block under the first data block.

4. The method according to claim 2, wherein the determining the reference relationship between the second data block and the second document on the basis of the target operation comprises:
determining the reference relationship between the second data block and the second document on the basis of a relative position relationship between the referenced data block moved to be under the second data block by the target operation and other sub-data blocks of the second data block.

5. The method according claim 1, further comprising:
determining whether the first data block has a reference relationship with the second document, wherein determining whether the first data block has a reference relationship with the second document comprises: determining whether the first data block is an associated data block of a selected region;
the determining the reference relationship between at least one data block in the first document and the second document on the basis of the target operation comprises: in response to the first data block is selected as the associated data block of the selected region, re-determining the associated data block and/or a range of the selected region on the basis of the target operation,
wherein the selected region is organized to describe a position and range of the referenced data block through the associated data block of the selected region and the range of the selected region; and the referenced data block is a data block referenced by at least one online document.

6. The method according to claim 5, wherein the re-determining the associated data block of the selected region on the basis of the target operation comprises:
in response to that all or a largest number of the referenced data blocks under the first data block are moved to be under the second data block by the target operation, changing the associated data block of the selected region from the first data block to the second data block.

7. The method according to claim 6, wherein the re-determining the range of the selected region on the basis of the target operation comprises:
re-determining the range of the selected region, on the basis of the relative position relationship between the referenced data block moved to be under the second data block by the target operation and other sub-data blocks of the second data block.

8. The method according to claim 5, wherein the re-determining the associated data block and/or range of the selected region on the basis of the target operation comprises:
if the target operation is used for moving the referenced data blocks in the first data block, keeping the associated data block of the selected region unchanged; and
re-determining the range of the selected region, on the basis of the relative position relationship between the moved referenced data blocks and other sub-data blocks of the first data block.

9. The method according to claim 5, wherein
the target operation is used for triggering a first operation instruction or triggering the first operation instruction and a second operation instruction; and the first operation instruction is used for editing the first data block, and the second operation instruction is used for editing other data blocks other than the first data block.

10. The method according to claim 9, wherein the re-determining the associated data block and/or range of the selected region on the basis of the target operation comprises:
determining an initial updating range of the selected region on the basis of the first operation instruction; and
if the initial updating range of the selected region is determined to be null on the basis of the first operation instruction, and a parent data block of the referenced data block deleted from the first data block is determined to be changed into other data blocks other than the first data block, using the parent data block containing the largest number of referenced data blocks deleted from the first data block as a new associated data block of the selected region, and determining a final range of the selected region according to the second operation instruction for the new associated data block.

11. The method according to claim 10, wherein the re-determining the associated data block and/or range of the selected region on the basis of the target operation comprises:
if the initial updating range of the selected region is determined to be not null on the basis of the first operation instruction, or the parent data block of the referenced data block deleted from the first data block is determined as not changing into other data blocks other than the first data block, using the initial updating range as the final range of the selected region.

12. The method according to claim 9, wherein the first operation instruction is used for deleting at least one sub-data block of the first data block, and the second operation instruction is used for inserting at least one sub-data block into other data blocks other than the first data block.

13. The method according to claim 9, wherein the target operation comprises a dragging operation for data blocks.

14. The method according to claim 5, wherein the range of the selected region has a left end point and a right end point, and the re-determining the range of the selected region on the basis of the target operation comprises:
if the target operation is used for adding or deleting N data blocks on a left side of the left end point of the selected region, increasing or decreasing corresponding numerical values of the left end point and the right end point of the selected region by N; or
if the target operation is used for adding or deleting N data blocks on a right side of the right end point of the selected region, keeping the corresponding numerical values of the left end point and the right end point unchanged; or
if the target operation is used for adding or deleting N data blocks between the left end point and the right end point of the selected region, increasing or decreasing the corresponding numerical value of the right end point of the selected region by N, and keeping the corresponding numerical values of the left end point unchanged,
wherein N is a positive integer.

15. The method according to claim 14, wherein the re-determining the range of the selected region on the basis of the target operation comprises:
if the target operation is used for increasing N data blocks to any end point of the selected region in an original document, keeping the range of the selected region unchanged; or
if the target operation is used for increasing N data blocks to the right end point of the selected region in a reference document, increasing all of the corresponding numerical values of the right end point of the selected region by N, and keeping the corresponding numerical values of the left end point of the selected region unchanged; or
if the target operation is used for increasing N data blocks to the left end point of the selected region in the reference document, increasing all of the corresponding numerical values of the left end point and the right end point of the selected region by N,
wherein the reference document is an online document which references one or more data blocks of the original document.

16. The method according to claim 5, wherein the re-determining the associated data block and/or range of the selected region on the basis of the target operation comprises:
if the target operation is used for dragging the referenced data block under the first data block to be parallel to the first data block, creating a new data block as the parent data block of the dragged referenced data block;
updating the associated data block of the selected region to be the new data block, wherein the new data block and the first data block have a common parent data block; and
updating the range of the selected region, on the basis of the number of the referenced data blocks dragged to be under the new data block by the target operation.

17. The method according to claim 16, wherein the target operation comprises a column division operation.

18. The method according to claim 5, further comprising:
determining selected region updating information on the basis of the re-determined associated data block and/or range of the selected region; and
transmitting the selected region updating information to a client, thereby enabling the client to update the selected region on the basis of the selected region updating information.

19-29. (canceled)

30. An electronic device, comprising:
at least one memory and at least one processor,
wherein the memory is configured to store program codes, and the processor is configured to call the program codes stored in the memory to enable the electronic device to execute a method for controlling a data block, and the method comprises:
receiving a target operation being performed on a first data block in a first document, wherein the first data block has a reference relationship with a second document, and the target operation comprises inserting, deleting, moving or replacing a sub-data block under the first data block; and
updating the reference relationship between at least one data block in the first document and the second document on the basis of the target operation.

31. A non-transient computer-readable storage medium, wherein
program codes are stored in the non-transient computer-readable storage medium; and when the program codes are executed by a computer device, the computer device is enabled to execute a method for controlling a data block, and the method comprises:
receiving a target operation being performed on a first data block in a first document, wherein the first data block has a reference relationship with a second document, and the target operation comprises inserting, deleting, moving or replacing a sub-data block under the first data block; and
updating the reference relationship between at least one data block in the first document and the second document on the basis of the target operation.
